(19) United States
(12) Patent Application Publication
(10) Pub. No.: US 2001/0047064 A1
(43) Pub. Date: Nov. 29, 2001

(54) Polymerizations using adjuvant catalyst

(75) Inventor: Lixin Sun, Odessa, TX (US)

Correspondence Address: Russell R. Stolle, Huntsman Corporation, P. O. Box 15730, Austin, TX, 78761, US

(73) Assignee: Huntsman Polymers Corporation, Odessa, TX (US)

(21) Appl. No.: 09/860,051

(22) Filed: May 17, 2001

Related U.S. Application Data
(63) Continuation-in-part of application No. 09/273,162, filed on Mar. 19, 1999.
(60) Provisional application No. 60/084,558, filed on May 6, 1998.

(51) Int. Cl. C08F 2/00

(52) U.S. Cl. 526/74; 526/113; 526/114; 526/116; 526/118; 526/119; 526/160; 526/943; 525/191; 525/240

(57) ABSTRACT

Disclosed herein are methods for producing polymeric materials which are normally tenacious in their character to such degree that their processing by conventional means is not possible, for example substantially-amorphous polyolefins. By introducing a second catalyst capable of producing a powdery polymer into the polymerization system during production of the sticky polymers, these normally sticky, tenacious polymers are rendered into a form which may be processed using conventional means and equipment.

### CROSS REFERENCES TO RELATED APPLICATIONS

This application is a Continuation-In-Part of previous application Ser. No. 09/273,162 filed Mar. 19, 1999, currently still pending, and claims benefit of U.S. Provisional Application No. 60/084,558 filed May 6, 1998.

### TECHNICAL FIELD

This invention relates generally to a method for producing low-crystallinity polyolefins. The invention relates more particularly to a method for producing sticky, tenacious polyolefins that normally adhere to the walls of the reactor in which they are produced to such degree that such polyolefins are considered by those skilled in the art as being impossible to manufacture and process in commercially-significant quantities. The invention relates further to processes useful for rendering such sticky, tenacious polyolefins processable using conventional polymer manufacturing and processing equipment.

### BACKGROUND INFORMATION

The polymerization of various olefins, including propylene, ethylene, and the like has been known in the chemical arts for some time. Generally speaking, in order to polymerize an olefin, one provides the olefin to be polymerized and contacts the olefin (monomer) with a catalytic material, which may include a co-catalyst, as the use of such in well-known in the art, under sufficient conditions of temperature and pressure to cause polymerization of the monomer to form a polymeric product which is conventionally referred to as a polymer. The conditions of temperature and pressure of the polymerization reaction may be varied, as well as the monomer(s) and catalyst(s) used and type of reaction vessel in which the polymerization is carried out. Also, hydrogen may be introduced during the polymerization to control the molecular weight of the polymer, and the use of hydrogen in this regard is well-known in the art.

One process for polymerization of olefins including, but not limited to propylene is known as the slurry process. In the slurry process, an inert organic solvent is fed into a closed reaction vessel and typically heated, with stirring. Then, a monomeric raw material is fed into the reaction vessel wherein some of the monomer dissolves in the solvent. Catalyst is fed to the stirred reactor and the monomer becomes polymerized. Polymer and solvent may be removed as a slurry, provided that the polymer, by its very nature, has no tendency to stick to the reactor walls, through a pipe in one of the sides or bottom of the reactor. The polymer is then separated by the solvent using means well known to those skilled in the polymer art, and the solvent is recycled. The process may be conducted as a batch process, and the monomer itself may function as the solvent, as in the case when propylene is employed under conditions in which it exists in the liquid state.

Another process useful for polymerizing olefins that is well-known to those skilled in the art is referred to as the “liquid pool” process, in which the solvent is an olefin which is to be polymerized in the polymerization. In such a process, the monomeric material (liquid propylene or other liquid alkene) and catalyst are fed into the reactor, which may be a stirred autoclave, and caused to polymerize by introducing catalyst (and co-catalyst if desired) under selected conditions of temperature, pressure, and added hydrogen.

High molecular weight amorphous and low-crystallinity polyolefins are commercially important for their use in diverse products due to the unique combination of chemical and physical properties they possess, including chemical inertness, softness, flexibility, recyclability. Industrial interest in these materials has increased in recent times by the development of catalysts to produce them, as taught specifically in U.S. patent

A number of patents disclose catalysts and processes to prepare amorphous or elastomeric polyolefins, including U.S. Pat. Nos. 4,524,195; 4,736,002; 4,971,936; 4,335,225; 5,118,768; 5,247,032; 5,539,056; 5,565,532; 5,608,018; 5,594,080; 5,948,720; 6,080,819; and 6,100,351, as well as European Patents EP 604908 and 693506, the entire contents of all aforesaid patents being herein incorporated by reference thereto. For purposes of this specification and the appended claims, the words “substantially amorphous” when referring to polyolefins means those having less than about 70 Joules per gram of crystallinity as measured using Differential Scanning Calorimetry according to ASTM method D-3417.

While the production of various high molecular weight amorphous polymers is possible owing to the relatively recent development of several catalysts therefor, it has been an ongoing problem in this art nevertheless that the harvest of these amorphous polyolefins from a reactor operated in liquid pool slurry processes has been thus far extremely difficult and in some cases even impossible to carry out on a commercial scale. This is because these sticky polymers typically tend to agglomerate on the walls and other portions of the reactor in which they are produced, thus fouling the reactor and other plant equipment. Among other complications caused by coatings of polymer on the walls of a reactor is that heat transfer capability between the walls of the vessel and the contents of the vessel is greatly reduced, which results in a reduced degree of control of the reaction conditions by the process operator. Such a loss of control of reaction temperature can have devastating consequences on the condition of the reactor, as well as the physical properties of the polymer products produced therein. Typically, to remove fouled material it is necessary to open the reactor and mechanically scrape the walls of the reaction vessel. Production of such “fouling” material is therefore viewed by those skilled in the art as being greatly undesirable, regardless of the properties of the polymeric materials so produced. This translates to a reduced overall potential for merchants of commerce to benefit the public by supplying polymers having hitherto unobserved and particularly useful physical properties. As used in this specification and the appended claims the words “fouling polymer” means a polyolefin polymer which adheres to the walls of the reactor in which it is produced to such an extent that commercial production of the polymer is hindered by reactor maintenance and cleansing requirements extraordinary with respect to those normally required for producing polymers which do not substantially adhere to the walls of the reactor in which they are produced, either in technique or frequency.

World Patents 96/11963 and 96/16996 describe solution processes for producing amorphous polyolefins. However, the processes therein set forth have the disadvantages of limitations on the viscosity, solids content, and include the use of one or more solvents, thus necessitating provisions for solvent recovery.

### INVENTION SUMMARY

In accordance with the foregoing disadvantages associated with catalysts and processes in the prior art which tend to produce polymers that substantially adhere to the walls of the vessel in which they are produced using a slurry process, it is an object of the instant invention to provide a method whereby high molecular weight, amorphous polymers which are sticky and tenacious enough to normally adhere to reactor walls are caused to be inert with respect to such adhesion.

The reactor fouling caused by agglomeration of sticky, amorphous polymer is eliminated or reduced in accordance with the instant invention by introduction of an effective anti-fouling amount of fine polymer powder dispersed in the reaction medium. The polymer powder is believed to coat the surface of the sticky, amorphous polymer particles to produce a less sticky surface having a reduced tendency to adhere to the reactor wall. In order to be effective towards this end, the powder must be of a small particle size, and be a non-sticky, free-flowing powder itself when in the dry state. The polymer powder is preferably an olefin polymer powder, although other polymers including without limitation those such as nylon, polypropylene and copolymers of propylene, polyethylene and copolymers of ethylene, polybutene and copolymers of butene, polyhexene and copolymers of hexene, polyoctene and copolymers of octene, styrene and its copolymers, and literally any other polymeric material which exists in a free-flowing powdery state having an average particle size of less than about 100 microns when dry, and which is capable of adhering to an amorphous sticky polymer as it is formed may be used, provided they don't interfere with the polymerization of the sticky amorphous olefin nor influence the physical properties of the sticky amorphous polymer in any adverse way. According to a preferred process according to the invention, the amorphous polymer has a molecular weight in the range of 100,000 and 800,000, including every molecular weight therebetween and wherein said polymer powder comprises a polymer selected from the group consisting of: polyethylene, polypropylene, polybutylene, polyhexene, polyoctene, polystyrene, and copolymers of any of the foregoing with a C₁-C₈ alkene

Since the desired polymers made in accordance with the invention are olefin polymers which are, by their nature, thermoplastic polyolefins, it is further desirable that a powdery polymer used to make the sticky, tenacious, amorphous polymers non-adherent to reactor equipment also be of a thermoplastic nature, in order to not give rise to problems during processing owing to inhomogeneity of the polymer melt.

It is well-known to those skilled in the art that catalysts used to produce commercial isotactic polypropylene do not produce a powder as herein defined, but rather form larger “granules” of polymer product, for which the processing equipment is designed to manipulate. Although the powdery polymer discussed herein may be added to the reaction mixture during polymerization of the sticky, tenacious, amorphous polymer in the form of a suspension in an inert solvent, it is most preferred that the powdery polymer be formed in situ during the polymerization of the sticky, tenacious, amorphous olefin polymer by the inclusion of a second catalyst in addition to the catalyst used to produce the amorphous material.

Thus, in a preferred form, the present invention is an improvement in a process for olefin polymerization which employs a first catalyst for producing a substantially amorphous, fouling polymer, wherein the improvement comprises: the presence in the polymerization reactor of an effective amount of a second catalyst which produces polyolefin powder simultaneously with said first catalyst to provide a powder polymer coating of the amorphous polymer during amorphous polymer formation so as to eliminate or substantially reduce the tendency of solid amorphous polymer to adhere to the walls (i.e., “fouling”) of the polymerization reactor and other equipment associated with producing a finished polymer product, which may be resin beads or particles, or a finished molded article or film.

Preferably, the powder is a polymer which is produced in-situ, in the reactor in which the polymerization of the olefin is carried out. This is preferably accomplished in accordance with this invention by the introduction of a special catalyst component which produces the desired powdery polymer without adversely affecting the performance of the main catalyst used for the olefin polymerization. Thus, in a preferred form the instant invention comprises a mixed catalyst system which produces two different polymers from the same monomeric raw material—the main sticky polymer, produced by the main catalyst; and the powdery polymer (which reduces the adhesion affinity of the main sticky polymer for the reactor walls) produced using the adjuvant catalyst.

The present invention is readily distinguishable from many prior art processes, such as those of the type taught in U.S. Pat. No. 6,080,819, in which the amorphous polymer is soluble in the solvent used, in such case toluene, and the isotactic polymer is insoluble in the solvent. In the present invention, on the other hand, both the substantially amorphous and the isotactic polymers are insoluble in the monomer, propylene, used in one preferred embodiment as the sole liquid pool medium. In systems in which the amorphous polymer is soluble in a solvent which is present, it is not possible for the presence of powdery polymer producing second catalyst to provide a coating on the particles of the amorphous polymer, since the amorphous polymer does not exist in particulate form that is capable of being coated owing to its solubility in the solvent. In the present invention, both the amorphous, fouling polymer and the powdery polymer are insoluble in the liquid monomer which is used as a solvent, which may be any liquid substance selected from ethylene, propylene, or butylene and which may optionally contain hexenes or octene, but is preferably composed predominantly of liquid propylene.

### DETAILED DESCRIPTION

The examples below are illustrative, but not delimiting, of the process of this invention. They show how the catalytic material Dimethylsilylbis(1-indenyl) zirconium dichloride functions to produce powdery polymers in accordance with this invention, simultaneously with other catalysts which produce sticky, amorphous polypropylenes. The effect of the catalyst which produces powdery polymers is to render the amorphous, sticky polymers inert with respect to adhesion to the walls of the reactor. For purposes of this specification and the appended claims, the word “powder” means a polymer which exists in a particulant form comprising a plurality of particles immediately upon its being produced in a reactor from at least one monomeric raw material, wherein the average size of the particles is below about 100 microns. Preferably, the average particle size is less than about 50 microns, more preferably, less than 40 microns, and most preferably, the average size of the particles is less than about 30 microns.

### Example 1

### Preparation of Fine Powder Polymer

A one-liter autoclave reactor equipped with a mechanical stirrer was purged with dry nitrogen and then with propylene in order to flush out residual atmospheric components. Then, 1.0 milligram of Dimethylsilylbis(1-indenyl) zirconium dichloride and 4.45 millimoles of modified methylaluminoxane (MMAO-4 from Akzo Chemicals Inc. of 300 S. Riverside Plaza, Chicago, Ill. 60606) were charged into the reactor, followed by the addition of 330 grams of liquid propylene. The reactor was heated and maintained at 50 degrees Centigrade for one hour under a fair amount of, but not vigorous, agitation. After venting off the unreacted monomer, 112 grams of crystalline fine polypropylene powder was recovered.

### Example 2

The same polymerization procedure as described in Example 1 was employed. 1.0 mg of Dimethylsilylbis(2-methyl-4-phenylindenyl)zirconium dichloride and 3.78 millimoles of modified methaluminoxane were charged into the reactor, followed by the addition of 330 grams of liquid polypropylene. The reactor was heated and maintained at 50 degrees centigrade for one hour under agitation. After venting off the unreacted monomer, 58 grams of crystalline polypropylene was obtained. The polymeric product, however, was an unmanageable mass, as it came out of the bench-scale reactor in the form of a single large chunk.

### Example 3

### Preparation of Unmanageable Amorphous Polypropylene (Sticky Main Polymer)

The same polymerization procedure as described in Example 1 was employed. 1.5 milligrams (mg) of (Tetramethylcyclopentadienyl-1-dimethylsilyl-t-butylamido) titanium was added to the reactor, followed by the addition of 330 grams of liquid propylene. The temperature of the reactor was maintained at 50 degrees centigrade for one hour. Visual observation through a sightglass in the reactor showed that the polymer formed had no particle form in the reaction medium and appeared to be gummy, semi-transparent, and stuck on the sightglass.

### Example 4

### Unmanageable Amorphous Polypropylene Made Manageable with Powdery Polymer

The same polymerization procedure as described in Example 3 was employed. 1.2 milligrams (mg) of (Tetramethylcyclopentadienyl-1-dimethylsilyl-t-butylamido)titanium dichloride and 0.3 mg of Dimethylsilylbis(1-indenyl) zirconium dichloride and 5.6 millimoles of MMAO (AKZO MMAO-4) were added to the reactor, followed by the addition of 330 grams of liquid propylene. The temperature of the reactor was maintained at 50 degrees centigrade for one hour. Visual observation through a sightglass in the reactor showed that the reaction medium appeared milky and contained a large amount of fine white particles as well as some larger (1-2 mm) white particles. Upon stopping the agitation, all particles fell down to the bottom and no polymer stuck to the window or the walls. None of the polymer was observed to be sticking to the sightglass or the reactor walls. It was clear that the presence of the Dimethylsilylbis (1-indenyl) zirconium dichloride and the MMAO had permitted production of the other sticky polymer without any of the latter becoming fouled on the reactor walls.

### Example 5

The same polymerization as in Example 3 was carried out using identical conditions except that 1.4 mg of (Tetramethylcyclopentadienyl-1-dimethylsilyl-t-butylamido) titanium dichloride and 0.1 mg of Dimethylsilylbis(1-indenyl)zirconium dichloride were employed.

### Example 6

The same polymerization as in Example 3 was carried out using identical conditions except that 1.45 mg of (Tetramethylcyclopentadienyl-1-dimethylsilyl-t-butylamido) titanium dichloride and 0.05 mg of Dimethylsilylbis(1-indenyl)zirconium dichloride were employed.

### Example 7

The same polymerization conditions as in Example 3 were employed using identical conditions except that 4.0 mg of Dimethylsilylbis (9-fluorenyl)zirconium, 0.3 mg of Dimethylsilylbis(1-indenyl)zirconium dichloride and 8.5 millimoles of MMAO-4 were employed as catalysts for propylene polymerization. The observation was the same as for Example 4—the reaction mixture was composed of tiny white particles and larger irregularly-shaped particles, which were well dispersed in the medium and not sticking to the walls of the reactor.

### Example 8

The same polymerization as in Example 7 was carried out using identical conditions except that the Dimethylsilylbis(1-indenyl)zirconium chloride was omitted. The polymer produced had no evidence of a particulant nature present, appeared to be gummy, was semi-transparent and adhered strongly to the walls of the reactor.

### Example 9

The same polymerization procedure as described in Example 3 was employed. 1.0 milligrams (mg) of (Tetramethylcyclopentadienyl-1-dimethylsilyl-t-butylamido)titanium dichloride and 0.5 mg of Dimethylsilylbis(2-methyl-4-phenylindenyl)zirconium dichloride and 5.6 millimoles of MMAO (AKZO MMAO-4) were added to the reactor, followed by the addition of 330 grams of liquid propylene. The temperature of the reactor was maintained at 50 degrees centigrade for one hour. Visual observation through a sightglass in the reactor showed that the polymer formed had no fine-particle form in the reaction medium and appeared to be sticking to the sightglass and the shaft of the agitator. After venting off the unreacted monomer, the polymeric product was so tough and strongly adhered to the reactor wall that it took a tremendous effort to scrape it out.

In Example 1 a fine powdery polymer was prepared using the catalyst stated therein. The polymer product existed in the form of a powder having an average particle size of about 30 microns, and after removal of all the unreacted monomer the polymer particles were free-flowing, and reminiscent in size of talcum powder or “baby powder” particles.

Example 2 shows a comparative result using another isospecific metallocene catalyst. Although it also made high crystallinity polymer as in Example 1, the polymer product was not powdery in the reaction medium, so it does not function as a fouling-preventative agent, such as is later illustrated in Example 9.

In Example 3 is taught the preparation of an unmanageable mass of sticky and tenacious amorphous polypropylene using a constrained geometry catalyst. Although the polymer produced by this process may have beneficial properties making it especially well-suited in particular end use applications where flexible polyolefins are desirable, its overall stickiness and tendency to adhere to the walls of the reactor again makes the recovery and further processibility of such a polymer impossible from a practicality standpoint.

In Example 4 is taught a process in accordance with the invention in which the unmanageable amorphous polypropylene polymer from Example 3 is made manageable by the inclusion in the polymerization reactor of a catalyst which produces a powdery polymer. In this example, reactor fouling is prevented as none of the polymer stuck to the reactor walls.

Examples 5 and 6 illustrate the effect of the ratio of amorphous polymer to powdery polymer. It was observed in Examples 5 and 6 that as the amount of Dimethylsilylbis (1-indenyl)zirconium was reduced, the reaction medium became less milky, indicating the presence of fewer particles of powdery polymer. This change was attended by a pendant increase in the size of the particles of amorphous polymer present. This establishes the relationship between the presence of the catalyst which produces powdery polymer and the tendency for the amorphous material simultaneously produced to stick to the reactor walls.

Examples 7 and 8 illustrate the invention using another amorphous polymer-producing catalyst. The unmanageable amorphous polypropylene polymer (Example 8) is made manageable by the inclusion of a catalyst which produces a powdery polymer in the polymerization reactor (Example 7).

Example 9 illustrates the use of a second isospecific catalyst which produces non-powdery crystalline polymer. Since the polymer produced does not have fine particle form, it cannot prevent the amorphous polymer from sticking to the reactor wall, and a tenacious messy mass of polymer was produced.

Comparing the results of the physical properties of the polymers from Example 4 with Example 9, it is seen that while both processes are carried out using as unsupported catalysts, both a tetramethyl Cp “constrained geometry” titanium dichloride catalyst; and a dimethylsilyl-bridged zirconium dichloride with indenyl-type ligands, along with an aluminoxane cocatalyst, the results of each of the polymerizations are quite different. In the case of Example 4, the adjuvant catalyst (used in Example 1) produced a powder product having a 30 micron average particle size, while in the case of Example 9, the adjuvant catalyst (used in Example 2) produced non-powdery polymer material. Thus, while Example 9 uses the same general polymerization conditions (i.e., propylene monomer, aluminoxane cocatalyst, similar temperature, similar ratio of catalysts, etc.) as were used in Example 4, entirely different results were obtained in each case, and reactor fouling was prevented in Example 4, but not Example 9.

There will always be a minimum preferred amount of powder-producing catalyst which is to be added to a given system in order to confer operability on the system, i.e., the ability of the system to produce continuously and in large quantity what would otherwise be a fouling polymer. As far as determining what the preferred relative amount of powder-producing catalyst to main polymer-producing catalyst present in the reactor is, the relative activity of the powder-producing catalyst as compared to that of the sticky polymer-producing catalyst is a factor. As the activity of the powder-producing polymer increases, the amount necessary for conferring operability to the system decreases. The ratio of powdery polymer to sticky polymer is important. This is dependent on the degree of stickiness of the sticky polymer. The more sticky the sticky polymer, the more powdery polymer will be required.

Typically, it is desired that the powdery polymer is produced in an amount equal to between about 1% and 60% of that of the total polymer produced in the presence of both types of catalysts. More preferably, the powdery polymer constitutes between about 3 and 40 (and every whole integer therebetween) percent of the total polymer produced. Generally speaking, the operability of a two catalyst system as disclosed herein increases as the amount of powder present increases. As long as the powdery polymer does not adversely affect the desired properties of the sticky polymer, any level of powdery polymer which is effective for producing sticky polymers without reactor fouling is satisfactory for achieving the objects of conferring operability to an otherwise fouled system.

One goal which is notably achieved by the process of the present invention is the rendering of otherwise unmanageable, tenacious, sticky amorphous polymers into a form which may be readily processed using conventional processing equipment. It is well-known in the art that while it is possible to produce a wide variety of polymers, not all are harvestable from industrial-scale manufacturing reactors owing to their inherent tenacity. This problem is discussed in detail in U.S. Pat. Nos. 5,948,447 and 6,143,842, both of which are herein incorporated by reference thereto. Each of these patents describe processes and non-conventional, inventive apparati for harvesting tenacious polymers, illustrating the fact that in many cases conventional processing equipment is unsuitable for amorphous polyolefins. One advantage of the present invention is that specialized equipment as described in the aforementioned patents is rendered unnecessary in the case of many polymers by my teachings. Such advantage not only saves money on capital investments, but also saves downtime associated with upgrading or altering a manufacturing plant to accommodate such equipment.

Although preferred embodiments of the invention have been described in the foregoing description, it must be borne in mind that the present invention is not limited to the specific embodiments disclosed herein, but is capable of numerous modifications by one of ordinary skill in the art after their reading and understanding this specification and the appended claims. Thus, it is understandable that the materials used and the chemical details may be slightly different or modified from the descriptions set forth herein without departing from the methods and compositions disclosed and taught by the present invention

What is claimed is:

1. In a liquid pool process for polymerizing propylene, which process employs a first catalyst that produces a substantially-amorphous, fouling, first propylene polymer that is insoluble in liquid propylene and has any molecular weight in the range of between 100,000 and 800,000, including every molecular weight therebetween, wherein the improvement comprises: the presence in the polymerization reactor of a second catalyst that produces a second propylene polymer that is insoluble in liquid propylene and that exists in the form of a powder, simultaneously with the first propylene polymer and in an effective amount sufficient to provide a coating of the second polymer powder about the fouling first propylene polymer during the formation of the first polymer that is effective to eliminate or substantially reduce the tendency of the first polymer to adhere to the walls of the polymerization reactor, thus yielding a propylene polymer product predominantly exhibiting the beneficial physical properties of the first propylene polymer while existing in a physical form that may be readily handled, stored, and processed by those in the polymer-product manufacturing industries using conventional equipment.

2. The process according to claim 1 wherein said first catalyst is either homogeneous or supported and is selected from the group consisting of: metallocene catalysts, Ziegler-Natta catalysts, and single-site catalysts.

3. The process according to claim 1 wherein said second catalyst produces olefin polymer particles having an average size of about 100 microns or less.

4. The process according to claim 1 wherein said second catalyst produces olefin polymer particles having an average size of about 50 microns or less.

5. The process according to claim 1 wherein said second catalyst produces olefin polymer particles having an average size of about 30 microns or less.

6. The process according to claim 1 wherein said second catalyst comprises an organometallic compound including at least one metal selected from the group consisting of: titanium, zirconium, and hafnium.

7. The process according to claim 6 wherein said second catalyst comprises an aromatic organosilicon ligand having a cyclopentadienyl portion coordinated to at least one metal selected from the group consisting of: titanium, zirconium, and hafnium.

8. The process according to claim 7 wherein said second catalyst comprises a dihalide of an organozirconium compound.

9. The process according to claim 1 wherein said second catalyst is an organometallic compound which includes an indenyl ligand, substituted or unsubstituted, coordinated to a metal selected from the group consisting of: titanium, hafnium, or zirconium.

10. A process as in to claim 9 wherein said second catalyst is selected from the group consisting of: Rac-ethylenebis(1-indenyl)zirconium dichloride and Dimethylsilylbis(1-indenyl)zirconiumdichloride.

11. A process according to claim 1 wherein both polymerizations are carried out at a temperature in the range of between 40 degrees centigrade and 60 degrees centigrade.

12. A process according to claim 1 wherein said first propylene polymer is a copolymer of propylene with at least one other monomer selected from the group consisting of: ethylene, 1-butene, 1-hexene, and 1-octene.

13. A process according to claim 1 wherein said second propylene polymer is a copolymer of propylene with at least on other monomer selected from the group consisting of: ethylene, 1-butene, 1-hexene, and 1-octene.

14. A process for rendering a normally unmanageable, tenacious, sticky, amorphous polymer into a form which is processable using conventional polymer processing equipment which comprises: causing an effective anti-fouling amount of a polymer powder to exist in the reactor in which said amorphous polymer is formed during its polymerization.

15. A process according to claim 14 wherein said polymer powder is caused to enter said reactor as a suspension in a solvent which is not detrimental to rendering said amorphous polymer into a processable form.

16. A process according to claim 14 wherein said amorphous polymer has a molecular weight in the range of 100,000 and 800,000, including every molecular weight therebetween and wherein said polymer powder comprises a polymer selected from the group consisting of: polyethylene, polypropylene, polybutylene, polyhexene, polyoctene, polystyrene, and copolymers of any of the foregoing with a C₁-C₈ alkene.

17. A process according to claim 15 in which said solvent is selected from the group consisting of: liquid ethylene, liquid propylene, liquid butylene, liquid hexene, liquid octene, toluene, benzene, and a xylene.

18. A process according to claim 16 wherein said powder has an average particle size of less than 50 microns.

19. A process according to claim 16 wherein said powder has an average particle size of less than 40 microns.

20. A process according to claim 16 in which said powder is present in an effective anti-fouling amount with respect to said amorphous polymer.
